(19) United States
(12) Patent Application Publication
(10) Pub. No.: US 2016/0219579 A1
(43) Pub. Date: Jul. 28, 2016

(54) USER TERMINAL, BASE STATION, AND PROCESSOR

(71) Applicant: KYOCERA CORPORATION, Kyoto (JP)

(72) Inventors: Chiharu YAMAZAKI, Ota-ku, Tokyo (JP); Noriyoshi FUKUTA, Yokohama-shi, Kanagawa (JP)

(73) Assignee: KYOCERA CORPORATION, Kyoto (JP)

(21) Appl. No.: 15/024,292

(22) PCT Filed: Sep. 24, 2014
(86) PCT No.: PCT/JP2014/075320

§ 371 Date: Mar. 23, 2016

(30) Foreign Application Priority Data
Sep. 26, 2013 (JP) 2013-199872

(51) Int. Cl. H04W 72/04; H04W 56/00; H04L 25/02; H04W 52/24; H04L 5/14; H04L 5/00

(52) U.S. Cl. CPC H04W 72/0413; H04L 5/14; H04L 5/0048; H04L 25/0228; H04W 52/243; H04W 56/003; H04W 72/042

(57) ABSTRACT

A reference signal period during which an uplink reference signal utilized in channel estimation is transmitted is partially set in downlink frequency f1. UE transmits uplink reference signal to eNB by using the downlink frequency f1 during the reference signal period. The eNB receives the uplink reference signal from the UE by using the downlink frequency f1 during the reference signal period.

### TECHNICAL FIELD

The present invention relates to a user terminal, a base station, and a processor used in a FDD communication system.

### BACKGROUND ART

LTE (Long Term Evolution), specifications of which have been designed in 3GPP (3rd Generation Partnership Project) which is a project aiming to standardize a mobile communication system, supports Frequency Division Duplex (FDD) in which communication is performed by using a downlink frequency and an uplink frequency.

In a mobile communication system that employs the FDD (that is, an FDD communication system), a user terminal feeds back, to a base station, channel state information (CSI) corresponding a channel state in the downlink frequency on the basis of a downlink reference signal that is transmitted from the base station by using the downlink frequency (for example, see Non Patent Literature 1).

The base station performs downlink transmission control on the basis of the CSI fed back from the user terminal. The downlink transmission control is, for example, downlink multi-antenna transmission control and/or a downlink scheduling.

Furthermore, in the 3GPP, introduction of a new carrier configuration (NCT: New Carrier Type) has been discussed, which is different from a conventional-type carrier configuration specified in the Releases 8 to 11.

In an FDD communication system, a CSI feedback is essential to perform downlink transmission control, and overhead due to the CSI feedback is a problem.

Further, an information amount of CSI that should be fed back increases because CSI with higher accuracy is needed when advancing the downlink transmission control, and overhead due to the CSI feedback is a serious problem.

### CITATION LIST

### Non Patent Literature

[NPL 1] 3GPP Technical Specification “TS 36.211 V11.3.0” June, 2013

### SUMMARY

A user terminal according to a first aspect is used in an FDD communication system in which communication is performed by using a downlink frequency and an uplink frequency. A reference signal period during which an uplink reference signal utilized in channel estimation is transmitted is partially set in the downlink frequency. The user terminal comprises a transmitter configured to transmit the uplink reference signal to a base station by using the downlink frequency during the reference signal period.

A base station according to a second aspect is used in an FDD communication system in which communication is performed by using a downlink frequency and an uplink frequency. A reference signal period during which an uplink reference signal utilized in channel estimation is transmitted is partially set in the downlink frequency. The base station comprises a receiver configured to receive the uplink reference signal from a user terminal by using the downlink frequency during the reference signal period.

A processor according to a third aspect is provided in a user terminal used in an FDD communication system in which communication is performed by using a downlink frequency and an uplink frequency. A reference signal period during which an uplink reference signal utilized in channel estimation is transmitted is partially set in the downlink frequency. The processor performs a process of transmitting the uplink reference signal to a base station by using the downlink frequency during the reference signal period.

### BRIEF DESCRIPTION OF DRAWINGS

FIG. 1 is a configuration diagram of an LTE system according to an embodiment.

FIG. 2 is a block diagram of a UE according to the embodiment.

FIG. 3 is a block diagram of an eNB according to the embodiment.

FIG. 4 is a protocol stack diagram of a radio interface according to the embodiment.

FIG. 5 is a configuration diagram of a radio frame according to the embodiment.

FIG. 6 is a diagram for describing an operation environment according to the embodiment.

FIG. 7 is a diagram for describing an NCT according to the embodiment.

FIG. 8 is an operation sequence chart according to the embodiment.

FIG. 9 is a diagram for describing a first modification of the embodiment.

FIG. 10 is a diagram for describing a second modification of the embodiment.

### DESCRIPTION OF EMBODIMENTS

[Overview of Embodiments]

A user terminal according to embodiments is used in an FDD communication system in which communication is performed by using a downlink frequency and an uplink frequency. A reference signal period during which an uplink reference signal utilized in channel estimation is transmitted is partially set in the downlink frequency. The user terminal comprises a transmitter configured to transmit the uplink reference signal to a base station by using the downlink frequency during the reference signal period.

In the embodiments, a stop period which overlaps with the reference signal period in a time direction is set in the uplink frequency. The user terminal comprises a controller configured to perform control to stop transmission by using the uplink frequency during the stop period.

In the embodiments, the user terminal comprises a receiver configured to receive a setting parameter of the reference signal period, where the setting parameter is transmitted from the base station by broadcast or unicast. The setting parameter includes at least one of a frequency at which the reference signal period is set, a time location of the reference signal period, and a time length of the reference signal period. The transmitter transmits the uplink reference signal to the base station by using the downlink frequency during the reference signal period that is set on the basis of the setting parameter.

In the embodiments, the user terminal comprises a receiver configured to receive, from the base station, a transmission parameter of the uplink reference signal, where the transmission parameter is transmitted by unicast from the base station. The transmission parameter includes information which specifies, among the reference signal period, a time resource and/or a frequency resource with which the uplink reference signal to be transmitted. The transmitter transmits the uplink reference signal to the base station by using the downlink frequency in a time resource and/or a frequency resource specified on the basis of the transmission parameter among the reference signal period.

In the embodiments, the user terminal comprises a controller configured to perform control to stop reception of a downlink reference signal from the base station during the reference signal period.

In the embodiments, the reference signal period is set, in the downlink frequency, so as to avoid a symbol interval including a cell-specific downlink reference signal.

In the embodiments, the user terminal comprises a controller configured to manage a first transmission timing correction value for correcting a timing of transmission by using the uplink frequency. The controller further manages a second transmission timing correction value for correcting a timing of transmitting the uplink reference signal by using the downlink frequency.

A base station according to the embodiments is used in an FDD communication system in which communication is performed by using a downlink frequency and an uplink frequency. A reference signal period during which an uplink reference signal utilized in channel estimation is transmitted is partially set in the downlink frequency. The base station comprises a receiver configured to receive the uplink reference signal from a user terminal by using the downlink frequency during the reference signal period.

In the embodiments, a stop period which overlaps with the reference signal period in a time direction is set in the uplink frequency. The base station comprises a controller configured to perform control to stop reception by using the uplink frequency during the stop period.

In the embodiments, the FDD communication system supports D2D communication that is direct device-to-device communication. The controller allows another user terminal to use the uplink frequency for the D2D communication during the stop period.

The base station according to the embodiments comprises a transmitter configured to transmit a setting parameter of the reference signal period to the user terminal by broadcast or unicast. The setting parameter includes at least one of a frequency at which the reference signal period is set, a time location of the reference signal period, and a time length of the reference signal period. The receiver receives the uplink reference signal from the user terminal by using the downlink frequency during the reference signal period that is set on the basis of the setting parameter.

The base station according to the embodiments comprises a transmitter configured to transmit, to the user terminal, a transmission parameter of the uplink reference signal by unicast. The transmission parameter includes, among the reference signal period, a time resource and/or a frequency resource with which the uplink reference signal to be transmitted. The receiver receives the uplink reference signal from the user terminal by using the downlink frequency in a time resource and/or a frequency resource specified on the basis of the transmission parameter among the reference signal period.

The base station according to the embodiments comprises a controller configured to perform control to stop transmission of a downlink reference signal during the reference signal period.

In the embodiments, the reference signal period is set, in the downlink frequency, so as to avoid a symbol interval including a cell-specific downlink reference signal.

The base station according to the embodiments, comprises a transmitter configured to transmit, to the user terminal, a first transmission timing correction value for correcting a timing of transmission by using the uplink frequency. The transmitter further transmits, to the user terminal, a second transmission timing correction value for correcting a timing of transmitting the uplink reference signal by using the downlink frequency.

A processor according to the embodiments is provided in a user terminal used in an FDD communication system in which communication is performed by using a downlink frequency and an uplink frequency. A reference signal period during which an uplink reference signal utilized in channel estimation is transmitted is partially set in the downlink frequency. The processor performs a process of transmitting the uplink reference signal to a base station by using the downlink frequency during the reference signal period.

### Embodiments

An embodiment of applying the present invention to the LTE system will be described below.

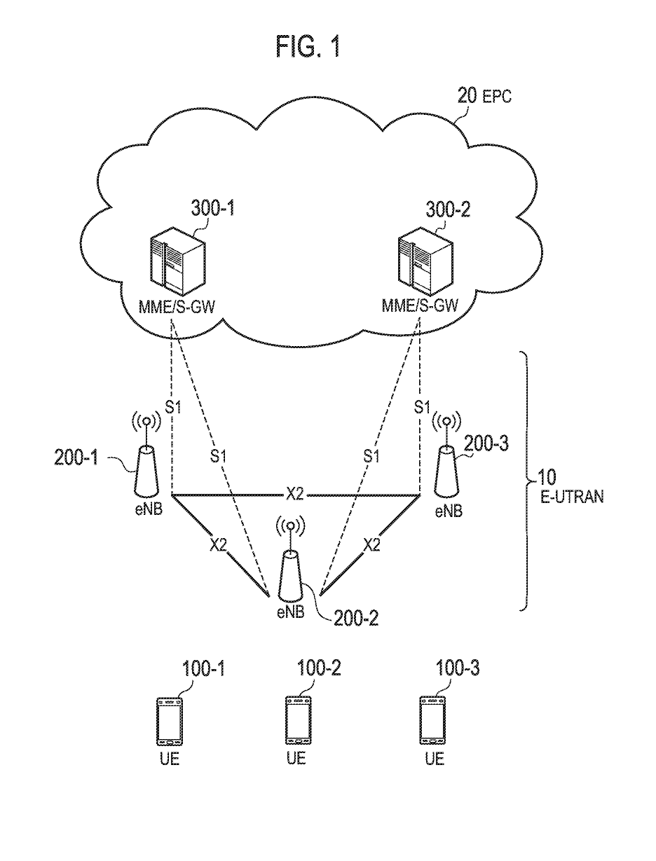

(System Configuration) FIG. 1 is a configuration diagram of an LTE system according to an embodiment. As illustrated in FIG. 1, the LTE system includes a plurality of UEs (User Equipments) 100, E-UTRAN (Evolved-UMTS Terrestrial Radio Access Network) 10, and EPC (Evolved Packet Core) 20.

The UE 100 corresponds to a user terminal. The UE 100 is a mobile communication device and performs radio communication with a cell (a serving cell) with which a connection is established. Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs200 are connected mutually via an X2 interface. Configuration of the eNB200 will be described later.

The eNB 200 manages one or a plurality of cells and performs radio communication with the UE 100 which establishes a connection with the cell of the eNB 200. The eNB 200 has a radio resource management (RRM) function, a routing function for user data, and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. A network of the LTE system is configured by the E-UTRAN 10 and the EPC 200. The EPC 20 includes a plurality of MME (Mobility Management Entity)/S-GWs (Serving-Gateways) 300. The MME performs various mobility controls and the like for the UE 100. The S-GW performs control to transfer user. MME/S-GW 300 is connected to eNB 200 via an S1 interface.

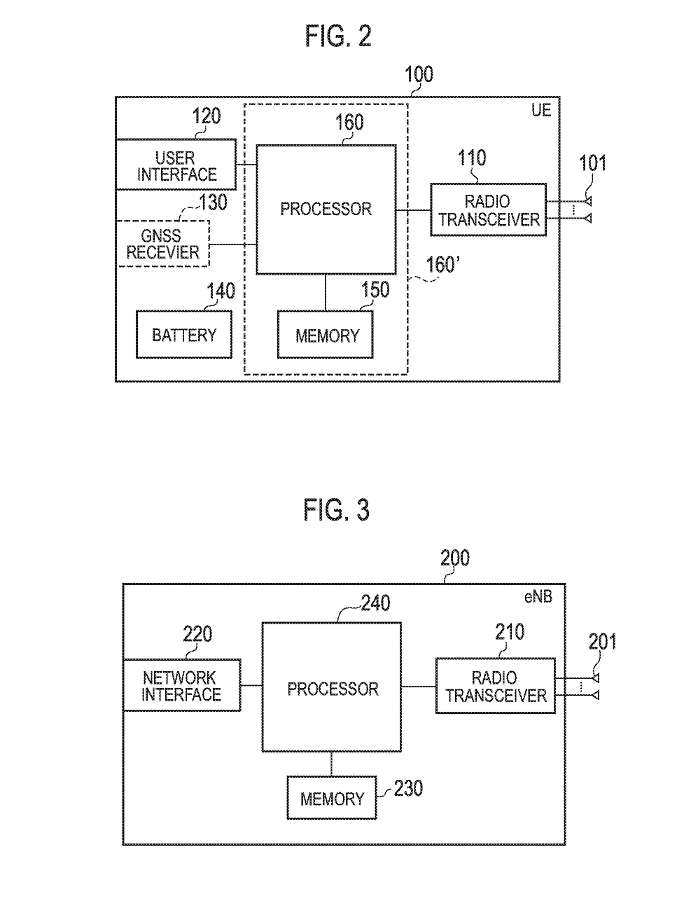

FIG. 2 is a block diagram of the UE 100. As illustrated in FIG. 2, the UE 100 includes plural antennas 101, a radio transceiver 110, a user interface 120, a GNSS (Global Navigation Satellite System) receiver 130, a battery 140, a memory 150, and a processor 160. The memory 150 and the processor 160 constitute a controller. The UE 100 may not have the GNSS receiver 130. Furthermore, the memory 150 may be integrally formed with the processor 160, and this set (that is, a chip set) may be called a processor 160′.

The plural antennas 101 and the radio transceiver 110 are used to transmit and receive a radio signal. The radio transceiver 110 converts a baseband signal (a transmission signal) output from the processor 160 into the radio signal and transmits the radio signal from the antenna 101. Furthermore, the radio transceiver 110 converts a radio signal received by the antenna 101 into a baseband signal (a received signal), and outputs the baseband signal to the processor 160.

The user interface 120 is an interface with a user carrying the UE 100, and includes, for example, a display, a microphone, a speaker, various buttons and the like. The user interface 120 accepts an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes plural antennas 201, a radio transceiver 210, a network interface 220, a memory 230, and a processor 240. The memory 230 and the processor 240 constitute a controller.

The plural antennas 201 and the radio transceiver 210 are used to transmit and receive a radio signal. The radio transceiver 210 converts a baseband signal (a transmission signal) output from the processor 240 into the radio signal and transmits the radio signal from the antenna 201. Furthermore, the radio transceiver 210 converts a radio signal received by the antenna 201 into a baseband signal (a received signal), and outputs the baseband signal to the processor 240.

The network interface 220 is connected to the neighboring eNB 200 via the X2 interface and is connected to the MME/S-GW 300 via the S1 interface. The network interface 220 is used in communication over the X2 interface and communication over the S1 interface.

The memory 230 stores a program to be executed by the processor 240 and information to be used for a process by the processor 240. The processor 240 includes a baseband processor that performs modulation and demodulation, encoding and decoding and the like on the baseband signal and CPU that performs various processes by executing the program stored in the memory 230. The processor 240 executes various processes and various communication protocols described later.

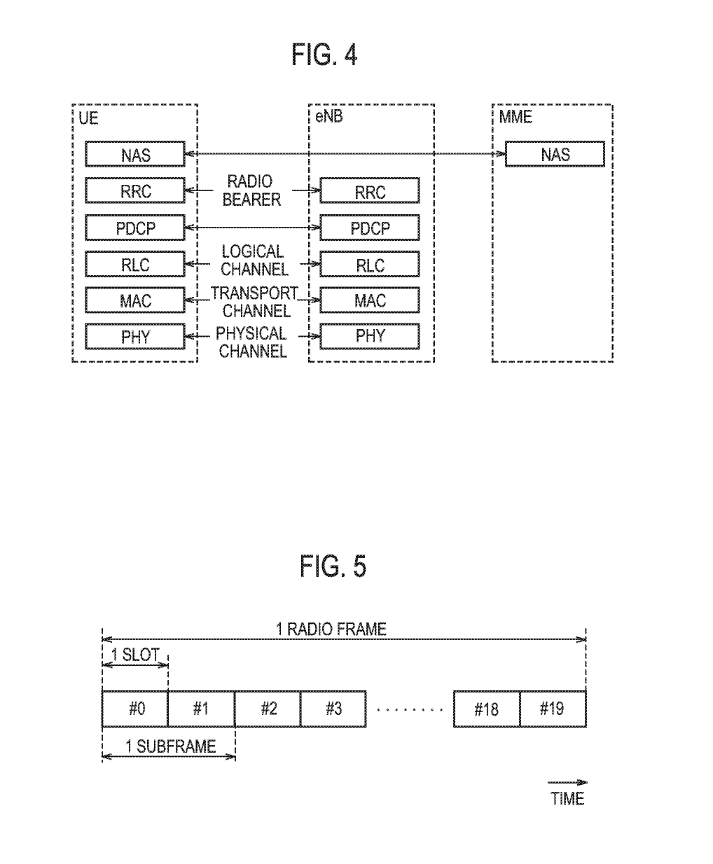

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Media Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, use data and control signal are transmitted via the physical channel.

The MAC layer performs priority control of data, a retransmission process by hybrid ARQ (HARQ), and the like. Between the MAC layer of the UE 100 and the MAC layer of the eNB 200, user data and control signal are transmitted via a transport channel. The MAC layer of the eNB 200 includes a scheduler that determines a transport format of an uplink and a downlink (a transport block size and a modulation and coding scheme (MCS)) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, control message (RRC messages) for various types of configuration are transmitted. The RRC layer controls the logical channel, the transport channel, and the physical channel in response to establishment, re-establishment, and release of a radio bearer. When there is an RRC connection between the RRC of the UE 100 and the RRC of the eNB 200, the UE 100 is in a connected state (an RRC connected state), otherwise the UE 100 is in an idle state (an RRC idle state).

A NAS (Non-Access Stratum) layer positioned above the RRC layer performs a session management, a mobility management and the like.

FIG. 5 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As illustrated in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. The resource block includes a plurality of subcarriers in the frequency direction. Resource element is configured by one subcarrier and one symbol.

Among radio resources assigned to the UE 100, a frequency resource is configured by a resource block and a time resource is configured by a subframe (or slot).

In the downlink, an interval of several symbols at the head of each subframe is a control region used as a physical downlink control channel (PDCCH) for mainly transmitting a control signal. Furthermore, the other interval of each subframe is a region available as a physical downlink shared channel (PDSCH) for mainly transmitting user data.

In the uplink, both ends in the frequency direction of each subframe are control regions used as a physical uplink control channel (PUCCH) for mainly transmitting a control signal. Furthermore, the central portion in the frequency direction of each subframe is a region available as a physical uplink shared channel (PUSCH) for mainly transmitting user data.

(Operation According to Embodiment)

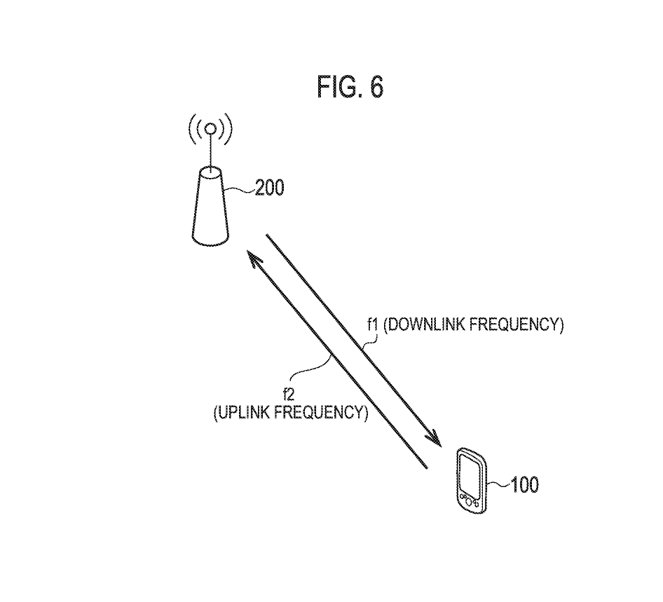

FIG. 6 is a diagram for describing an operation environment according to the embodiment.

As shown in FIG. 6, the LTE system according to the embodiment is a FDD communication system that perform communication by using a downlink frequency f1 and an uplink frequency f2. In the FDD communication system, a channel state in the downlink frequency f1 and a channel state in the upload frequency f2 are different.

In the general FDD communication system, the UE 100 performs channel estimation on the basis of a downlink reference signal that is transmitted from the eNB 200 by using the downlink frequency f1, and feeds back CSI corresponding a channel state in the downlink frequency f1 to the eNB 200.

The downlink reference signal includes a CRS (Cell-specific Reference Signal), a CSI-RS (Channel State Information-Reference Signal), etc. The CRS is a cell-specific downlink reference signal. The CRS and the CSI-RS are used in the channel estimation to acquire the CSI (that is, CSI measurement). The CRS is also used in received power (RSRP: Reference Signal Received Power) measurement for mobility control other than the channel estimation.

The CSI includes channel quality information (CQI; Channel Quality Indicator), precoder matrix information (PMI; Precoder Matrix Indicator), rank information (RI; Rank Indicator), etc. The CQI is an index indicating a modulation and coding scheme (MCS) that is recommended in the downlink. The PMI is an index indicating a precoder matrix that is recommended in the downlink. The RI is an index indicating a rank that is recommended in the downlink.

The eNB 200 performs the downlink transmission control on the basis of the CSI fed back from the UE 100. The downlink transmission control is, for example, the downlink multi-antenna transmission and/or the downlink scheduling. For example, the eNB 200 controls the downlink multi-antenna transmission on the basis of the PMI and the RI. Furthermore, the eNB 200 performs the downlink scheduling on the basis of the CQI.

Thus, in the general FDD communication system, the CSI feedback is essential to perform the downlink transmission control, and overhead due to the CSI feedback is the problem. Further, an information amount of CSI that should be fed back increases because CSI with higher accuracy is needed when advancing the downlink transmission control, and overhead due to the CSI feedback is a serious problem. Furthermore, with current CSI accuracy, it is difficult to introduce an advanced multi-antenna transmission such as MU-MIMO (Multi User Multiple-Input Multiple-Output).

Therefore, in the embodiment, in order to resolve this problem, a new carrier configuration (NCT) is introduced, which is different from a conventional-type carrier configuration that is specified in the Releases 8 to 11.

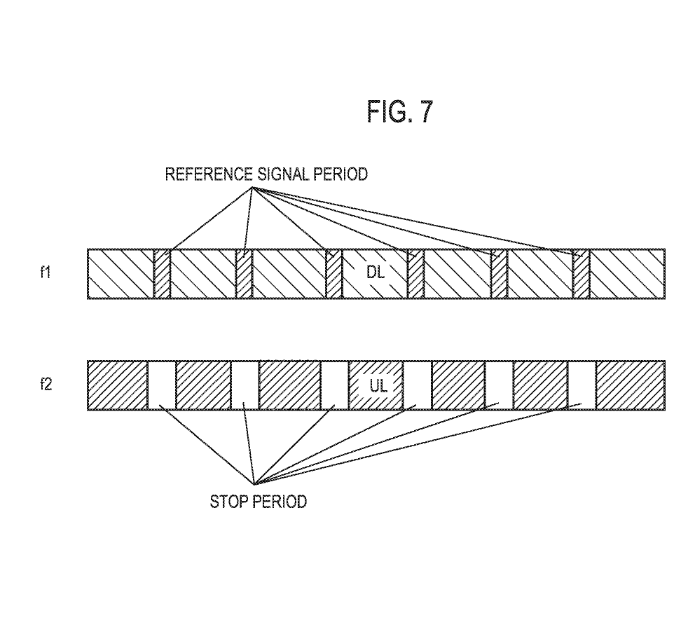

FIG. 7 is a diagram for describing an NCT according to the embodiment.

As shown in FIG. 7, in the downlink frequency f1, a reference signal period during which an uplink reference signal utilized in the channel estimation is transmitted is partially set. The reference signal period is set, for example, in a symbol unit, a slot unit, or a subframe unit. The UE 100 transmits the uplink reference signal to the eNB 200 by using the downlink frequency f1 during the reference signal period. The eNB 200 receives the uplink reference signal from the UE 100 by using the downlink frequency f1 during the reference signal period.

As a result, the eNB 200 is capable of performing the channel estimation for the downlink frequency f1, on the basis of the uplink reference signal received from the UE 100. Thus, the eNB 200 is capable of obtaining the CSI of the downlink frequency f1 by the eNB 200 itself, without depending on the CSI feedback from the UE 100. Therefore, it is possible to reduce overhead due to the CSI feedback. Further, it is possible to introduce an advanced multi-antenna transmission such as MU-MIMO.

The uplink reference signal is a known signal sequence in the eNB 200 and is defined by a cyclic shift amount and a fundamental sequence. For example, in the fundamental sequence, it is possible to apply a Zadoff-Chu sequence, which has fixed amplitude in the both regions of time and frequency and in which cyclic-shifted sequences are orthogonal to each other. The uplink reference signal may be a sounding reference signal (SRS). In transmitting the SRS, frequency hopping is applied. That is, a transmission frequency of the SRS is switched for each transmission cycle of the SRS.

However, when setting the reference signal period to the downlink frequency f1, there is a possibility that a collision between the downlink reference signal and the uplink reference signal during the reference signal period may occur. Thus, in the embodiment, the eNB 200 performs control to stop transmission of the downlink reference signal during the reference signal period. The UE 100 performs control to stop reception of the downlink reference signal from the eNB 200 during the reference signal period. As a result, it is possible to prevent an occurrence of the collision between the downlink reference signal and the uplink reference signal during the reference signal period.

Further, when the UE 100 performs transmission simultaneously at the downlink frequency f1 and the uplink frequency f2, transmission power shortage of the UE 100 may occur. Thus, in the uplink frequency f2, a stop period is set which overlaps with the reference signal period in the time direction. In order to secure switching time for transmission circuit of the UE 100, the stop period may be a longer period than the reference signal period. The UE 100 performs control to stop transmission by using the uplink frequency f2 during the stop period. The eNB 200 performs control to stop reception using the uplink frequency f2 during the stop period.

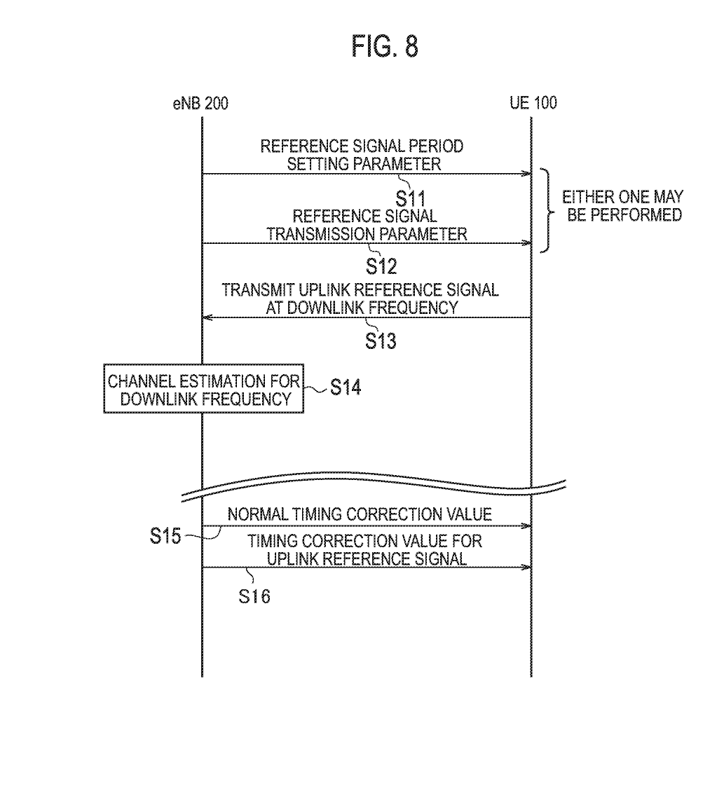

Next, an operation sequence according to the embodiment will be described. FIG. 8 is a sequence chart according to the embodiment.

As shown in FIG. 8, in step S11, the eNB 200 transmits a setting parameter of the reference signal period to the UE 100 by broadcast or unicast. The setting parameter is transmitted by an RRC message (Common) or an RRC message (Dedicated), for example. The setting parameter includes a parameter which specifies at least one of a frequency at which the reference signal period is set, a time location of the reference signal period, and a time length of the reference signal period. These parameters may be specified, for example, in a symbol unit, a slot unit, or a subframe unit. The UE 100 that receives the setting parameter stores a setting (Configuration) of the reference signal period specified by the setting parameter.

In step S12, the eNB 200 transmits a transmission parameter of the uplink reference signal to the UE 100 by unicast. The transmission parameter is transmitted by an RRC message (Dedicated), for example. The transmission parameter includes a parameter which specifies, among the reference signal period, a time resource and/or a frequency resource with which the uplink reference signal to be transmitted. The time resource is, for example, a symbol, a slot, or a subframe. The frequency resource is, for example, a resource block. The UE 100 that receives the transmission parameter stores a transmission setting (Configuration) of the uplink reference signal specified by the transmission parameter.

It is noted that when utilizing the SRS as the uplink reference signal, the transmission parameter may include a transmission bandwidth, a transmission cycle, a hopping bandwidth, a transmission start band, a transmission power, etc. The transmission bandwidth is a frequency bandwidth when transmitting an uplink reference signal. The transmission cycle is a cycle at which an uplink reference signal is transmitted. The hopping bandwidth is a parameter for determining whether or not hopping is performed. The transmission start band is a frequency band in which an uplink reference signal is initially transmitted in the hopping bandwidth. The transmission power is a transmission power of an uplink reference signal.

Alternatively, when assigning, from the eNB 200, a downlink radio resource corresponding to a reference signal period, the UE 100 may transmit an uplink reference signal by the downlink radio resource. However, when considering that it is not appropriate that the UE 100 to which a wideband radio resource is assigned in the downlink performs uplink transmission throughout the entire resources (a UE at the edge of a cell may be saturated with transmission power when bandwidth is too wide), it may be preferable to transmit an uplink reference signal by using only a part of the resource block assigned in the downlink. Therefore, it is desirable to notify, as the transmission parameter, a parameter for determining a resource block in which an uplink reference signal is transmitted (for example, the transmission bandwidth, and the start position).

It is noted that steps S11 and S12 may be performed simultaneously. Further, only one of steps S11 and S12 may be performed.

In step S13, the UE 100 transmits an uplink reference signal to the eNB 200 by using the downlink frequency f1 during the reference signal period. In the embodiment, the UE 100 transmits an uplink reference signal by using a time resource and/or a frequency resource specified on the basis of the transmission parameter among the reference signal period set in the downlink frequency f1 on the basis of the setting parameter.

In step S14, the eNB 200 performs the channel estimation for the downlink frequency f1 on the basis of the uplink reference signal received from the UE 100. In this way, the eNB 200 is capable of obtaining the CSI of the downlink frequency f1 by the eNB 200 itself, without depending on the CSI feedback from the UE 100. The eNB 200 may perform an advanced multi-antenna transmission such as MU-MIMO on the basis of the CSI obtained by itself.

Next, uplink transmission timing control will be described. In the uplink, the UE 100 remote from eNB 200 needs to advance a transmission timing so as to match with a reception timing of the eNB 200. Thus, the eNB 200 generates a timing correction value for correcting a transmission timing of the UE 100 by measuring a timing of an uplink signal received from the UE 100, and transmits the timing correction value to the UE 100 as a TA MCE (Timing Advance Command Mac Control Element). As described above, a channel state in the downlink frequency f1 differs from a channel state in the uplink frequency f2, therefore in the embodiment, two types of timing correction values described below will be used.

As shown in FIG. 8, in step S15, the eNB 200 transmits, to the UE 100, a normal timing correction value (first transmission timing correction value) for correcting a timing of transmission by using the uplink frequency f2. The first timing correction value may be an absolute value or a difference value. The UE 100 manages the first transmission timing correction value. The UE 100 corrects the timing of transmission by using the uplink frequency f2, on the basis of the first transmission timing correction value managed by the UE 100.

In step S16, the eNB 200 transmits, to the UE 100, a timing correction value (second transmission timing correction value) for correcting a timing of transmitting the uplink reference signal using the downlink frequency f1. The second timing correction value may be an absolute value or a difference value. The UE 100 manages the second transmission timing correction value. The UE 100 corrects the transmission timing of the uplink reference signal using the downlink frequency f1, on the basis of the second transmission timing correction value managed by the UE 100.

(Summary of Embodiment)

As described above, in the downlink frequency f1, a reference signal period during which an uplink reference signal utilized in the channel estimation is transmitted is partially set. The UE 100 transmits the uplink reference signal to the eNB 200 by using the downlink frequency f1 during the reference signal period. The eNB 200 receives the uplink reference signal from the UE 100 by using the downlink frequency f1 during the reference signal period.

As a result, the eNB 200 is capable of performing the channel estimation for the downlink frequency f1, on the basis of the uplink reference signal received from the UE 100. Thus, the eNB 200 is capable of obtaining the CSI of the downlink frequency f1 by the eNB 200 itself, without depending on the CSI feedback from the UE 100. Therefore, it is possible to reduce overhead due to the CSI feedback as well as to introduce an advanced multi-antenna transmission such as MU-MIMO.

[First Modification]

In the above-described embodiment, the eNB 200 stops transmission of a downlink reference signal during the reference signal period. On the other hand, in a first modification of the embodiment, the reference signal period is set, in the downlink frequency f1, so as to avoid a symbol interval including a cell-specific downlink reference signal (CRS). This prevents an adverse influence to be imposed on an RSRP measurement for mobility control, etc.

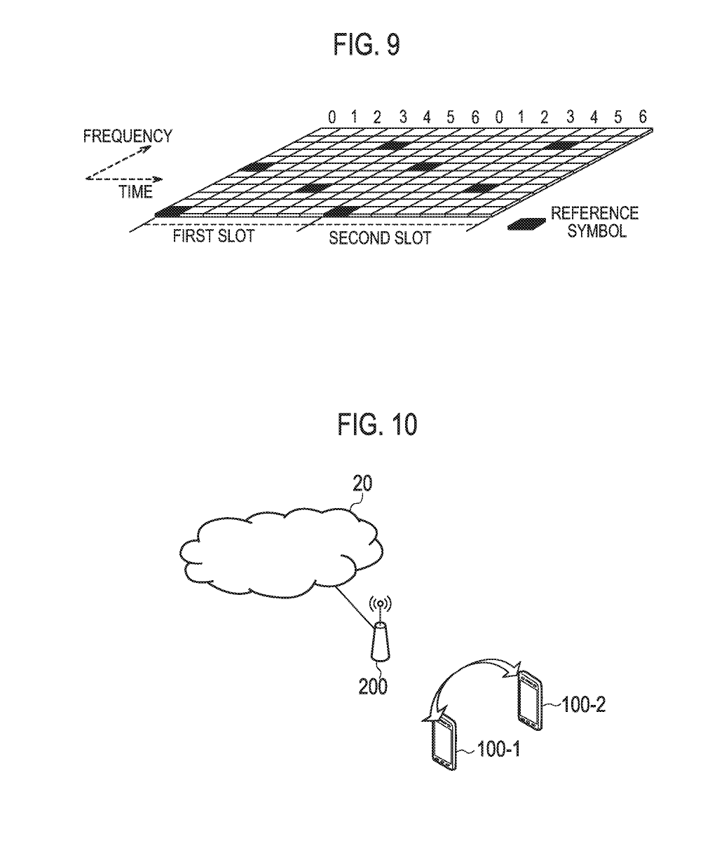

FIG. 9 is a diagram for describing the first modification of the embodiment. FIG. 9 shows a resource configuration in the time of one subframe as well as the frequency of one resource block.

As shown in FIG. 9, when a normal cyclic prefix (CP) setting is applied, a symbol corresponding to the CRS (reference symbol) is arranged in symbols #0 and #4 in each slot. Therefore, the reference signal period is set in a symbol interval other than the symbols #0 and #4 in each slot. Actually, it is preferable to secure also each one symbol before and after the reference symbol as guard time for suppressing the interference to surrounding UEs. Therefore, the reference signal period may be set to the symbol #2 in each slot and the guard time may be set to the symbols #1 and #3 in each slot.

It is noted that, in terms of antenna ports #2 and #3, when the eNB 200 has a four antenna ports configuration, the reference symbol (CRS) is arranged in the symbol #1 in each slot, therefore setting the symbol #1 as the guard period may cause collision with the CRSs of the antenna ports #2 and #3. However, the CRSs of the antenna ports #2 and #3 are used only for CSI measurement and demodulating, and thus, as for the CSI measurement, it is possible to avoid collision with another UE by config of a CSI report, and as for the demodulating, only the UE transmitting the uplink reference signal is influenced, therefore it is considered not to be a significant problem as long as the CRI of the symbol #1 is not received.

[Second Modification]

In the above-described embodiment, in the uplink frequency f2, the stop period is set which overlaps with the reference signal period in the time direction. Therefore, the uplink frequency f2 is not used during the stop period. However, in order to improve frequency usage efficiency, the uplink frequency f2 may be used for another purpose during the stop period. Another purpose includes D2D communication that is direct device-to-device communication. The eNB 200 allows the UE 100 to use the uplink frequency f2 for D2D communication during the stop period.

FIG. 10 is a diagram for describing D2D communication according to the second modification of the embodiment. Here, D2D communication is described in comparison with cellular communication that is normal communication of the LTE system. In the cellular communication, a data path passes through a network (E-UTRAN 10, EPC 20). The data path is a transmission path for user data. On the other hand, as shown in FIG. 10, in the D2D communication, a data path set between UEs does not pass through the network. A plurality of UEs 100 adjacent to one another (a UE 100-1 and a UE 100-2) directly perform radio communication with low transmission power in a cell of the eNB 200.

By notifying the UE 100-1 and the UE 100-2 of D2D resource information indicating the uplink frequency f2 and the stop period, the eNB 200 is capable of allowing the UE 100-1 and the UE 100-2 to use the uplink frequency f2 for the D2D communication during the stop period.

### Other Embodiments

In the above-described embodiment, the existence of a UE that does not support an NCT (a legacy UE) is not particularly mentioned; however, it is possible to allow the legacy UE as well to utilize the downlink frequency f1 and the uplink frequency f2, by mixing a normal subframe into the downlink frequency f1 and the uplink frequency f2.

In the above-described first modification, the reference signal period is set, in the downlink frequency f1, so as to avoid the symbol interval including the CRS. However, in addition to the CRS, a primary synchronization signal (PSS), a secondary synchronization signal (SSS), and a master information block (MIB) are also important, and thus it is preferable to set the reference signal period so as to avoid subframes #0 and #5 including the PSS, the SSS, and the MIB.

In each of the above-described embodiments, as one example of the cellular communication system, the LTE system is described; however, the present invention is not limited to the LTE system, and the present invention may be applied to systems other than the LTE system.

Although not particularly mentioned in the embodiments, a program may be provided for causing a computer to execute each process performed by the UE 100. Further, the program may be recorded on a computer-readable medium. By using the computer-readable medium, it is possible to install the program in a computer. Here, the computer-readable medium recording the program thereon may include a non-transitory recording medium. The non-transitory recording medium is not particularly limited; the non-transitory recording medium may include a recording medium such as a CD-ROM or a DVD-ROM, for example.

Alternatively, a chip, which includes a memory for storing the program for executing each process performed by the UE 100, and a processor (the above-described processor 160 or processor 160′) for executing the program stored in the memory, may be provided.

It is noted that the entire content of Japanese Patent Application No. 2013-199872 (filed on Sep. 26, 2013) is incorporated in the present description by reference.

### INDUSTRIAL APPLICABILITY

According to the present invention, it is possible to reduce overhead due to CSI feedback.

1. A user terminal used in an FDD communication system in which communication is performed by using a downlink frequency and an uplink frequency, wherein
a reference signal period during which an uplink reference signal utilized in channel estimation is transmitted is partially set in the downlink frequency, comprising:
a transmitter configured to transmit the uplink reference signal to a base station by using the downlink frequency during the reference signal period.

2. The user terminal according to claim 1, wherein a stop period which overlaps with the reference signal period in a time direction is set in the uplink frequency, comprising:
a controller configured to perform control to stop transmission by using the uplink frequency during the stop period.

3. The user terminal according to claim 1, comprising a receiver configured to receive a setting parameter of the reference signal period, where the setting parameter is transmitted from the base station by broadcast or unicast, wherein
the setting parameter includes at least one of a frequency at which the reference signal period is set, a time location of the reference signal period, and a time length of the reference signal period, and
the transmitter transmits the uplink reference signal to the base station by using the downlink frequency during the reference signal period that is set on the basis of the setting parameter.

4. The user terminal according to claim 1, comprising a receiver configured to receive, from the base station, a transmission parameter of the uplink reference signal, where the transmission parameter is transmitted by unicast from the base station, wherein
the transmission parameter includes information which specifies, among the reference signal period, a time resource and/or a frequency resource with which the uplink reference signal to be transmitted, and
the transmitter transmits the uplink reference signal to the base station by using the downlink frequency in a time resource and/or a frequency resource specified on the basis of the transmission parameter among the reference signal period.

5. The user terminal according to claim 1, comprising a controller configured to perform control to stop reception of a downlink reference signal from the base station during the reference signal period.

6. The user terminal according to claim 1, wherein the reference signal period is set, in the downlink frequency, so as to avoid a symbol interval including a cell-specific downlink reference signal.

7. The user terminal according to claim 1, comprising a controller configured to manage a first transmission timing correction value for correcting a timing of transmission by using the uplink frequency, wherein
the controller further manages a second transmission timing correction value for correcting a timing of transmitting the uplink reference signal by using the downlink frequency.

8. A base station used in an FDD communication system in which communication is performed by using a downlink frequency and an uplink frequency, wherein
a reference signal period during which an uplink reference signal utilized in channel estimation is transmitted is partially set in the downlink frequency, comprising:
a receiver configured to receive the uplink reference signal from a user terminal by using the downlink frequency during the reference signal period.

9. The base station according to claim 8, wherein a stop period which overlaps with the reference signal period in a time direction is set in the uplink frequency, comprising:
a controller configured to perform control to stop reception by using the uplink frequency during the stop period.

10. The base station according to claim 9, wherein the FDD communication system supports D2D communication that is direct device-to-device communication, and
the controller allows another user terminal to use the uplink frequency for the D2D communication during the stop period.

11. The base station according to claim 8, comprising a transmitter configured to transmit a setting parameter of the reference signal period to the user terminal by broadcast or unicast, wherein
the setting parameter includes at least one of a frequency at which the reference signal period is set, a time location of the reference signal period, and a time length of the reference signal period, and
the receiver receives the uplink reference signal from the user terminal by using the downlink frequency during the reference signal period that is set on the basis of the setting parameter.

12. The base station according to claim 8, comprising a transmitter configured to transmit, to the user terminal, a transmission parameter of the uplink reference signal by unicast, wherein
the transmission parameter includes, among the reference signal period, a time resource and/or a frequency resource with which the uplink reference signal to be transmitted, and
the receiver receives the uplink reference signal from the user terminal by using the downlink frequency in a time resource and/or a frequency resource specified on the basis of the transmission parameter among the reference signal period.

13. The base station according to claim 8, comprising a controller configured to perform control to stop transmission of a downlink reference signal during the reference signal period.

14. The base station according to claim 8, wherein the reference signal period is set, in the downlink frequency, so as to avoid a symbol interval including a cell-specific downlink reference signal.

15. The base station according to claim 8, comprising a transmitter configured to transmit, to the user terminal, a first transmission timing correction value for correcting a timing of transmission by using the uplink frequency, wherein
the transmitter further transmits, to the user terminal, a second transmission timing correction value for correcting a timing of transmitting the uplink reference signal by using the downlink frequency.

16. A processor provided in a user terminal used in an FDD communication system in which communication is performed by using a downlink frequency and an uplink frequency, wherein
a reference signal period during which an uplink reference signal utilized in channel estimation is transmitted is partially set in the downlink frequency, and
the processor performs a process of transmitting the uplink reference signal to a base station by using the downlink frequency during the reference signal period.
